(19) United States
(12) Patent Application Publication
(10) Pub. No.: US 2015/0189041 A1
(43) Pub. Date: Jul. 2, 2015

(54) SERVER AND SYSTEM AND METHOD FOR MANAGEMENT AND SHARING OF PERSONAL DIGITAL RESOURCES

(71) Applicant: Industrial Technology Research Institute, Hsinchu (TW)

(72) Inventors: Ching-Yao WANG, Tainan City (TW); Chuan-Wei TING, Zhubei City (TW); Yian-Shu CHU, New Taipei City (TW)

(21) Appl. No.: 14/340,975

(22) Filed: Jul. 25, 2014

(30) Foreign Application Priority Data
Dec. 27, 2013 (TW) 102148614

(51) Int. Cl. H04L 29/08

(52) U.S. Cl. CPC H04L 67/306; H04L 67/1097

(57) ABSTRACT

A server for management and sharing of personal digital resources. The server includes a communication unit, a storage unit and a computing unit. Via the communication unit, the computing unit communicates with users on internet for the digital resources of the users. The users and the digital resources of the users are archived in the storage unit. The behavioral preferences of each user regarding his own digital resources and the access rights to the digital resources that each user sets for other users are also recorded in the storage unit. The digital resources include terminal devices and internet services. Based on data contained in the storage unit and via the communication unit, the computing unit manages the digital resources of each user and the digital resources are shared between the users.

### CROSS REFERENCE TO RELATED APPLICATIONS

This application claims priority of Taiwan Patent Application No. 102148614, filed on Dec. 27, 2013, the entirety of which is incorporated by reference herein.

### BACKGROUND OF THE INVENTION

1. Technical Field

The present invention relates to server technology and in particular to managing and sharing personal digital resources.

2. Related Art

With the development of intelligent household appliances, personal digital devices, and cloud computing technology, the number of personally owned digital resources has dramatically increased. It is a hot topic to make good use of personal digital resources.

### SUMMARY

A server in accordance with an exemplary embodiment of the disclosure is provided for the management and sharing of personal digital resources. The server includes a communication unit, a storage unit, and a computing unit. The communication unit is provided for linking to the internet. Via the communication unit, the computing unit communicates with users on the internet for digital resources belonging to the users. By the computing unit, the users and the digital resources of the users are archived in the storage unit, and the behavioral preferences of each user regarding his own digital resources and the access rights to the digital resources that each user sets for other users are also recorded in the storage unit. The digital resources include terminal devices and internet services. Based on data contained in the storage unit and via the communication unit, the computing unit manages the digital resources of each user and the digital resources are shared between the users.

A management and sharing system for personal digital resources in accordance with an exemplary embodiment of the disclosure includes the aforementioned server and the digital resources of the different users. Each user has at least one digital resource having a GUI (Graphic User Interface) application installed and executed thereon for communication between the users and the server.

A management and sharing method for personal digital resources in accordance with an exemplary embodiment of the disclosure includes: archiving digital resources of users on internet in a storage unit of a server, the digital resources including terminal devices and internet services; recording, into the storage unit, the behavioral preferences of each user regarding his own digital resources and the access rights to the digital resources that each user sets for other users; and, based on data contained in the storage unit, driving the server to manage the digital resources of each user through internet and make the digital resources shared between the users through internet.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 depicts a management and sharing system 100 for personal digital resources in accordance with an exemplary embodiment of the disclosure;

FIG. 2 is a flowchart depicting a management and sharing method for personal digital resources in accordance with an exemplary embodiment of the disclosure;

FIG. 3 shows the archiving of digital resources of a user, including the behavioral preferences of the user regarding his own digital resources and the access rights to the digital resources that the user sets for other users;

FIG. 4 is a flowchart depicting integral communication of terminal devices and internet services of one single user in accordance with an exemplary embodiment of the disclosure;

FIG. 5 shows an example of the integral communication of FIG. 4;

FIG. 6 is a flowchart depicting community sharing of terminal devices and internet services in accordance with an exemplary embodiment of the disclosure;

FIG. 7 shows an example of the community sharing of FIG. 6;

FIG. 8 is a flowchart depicting community sharing of digital information in accordance with an exemplary embodiment of the disclosure; and

FIG. 9 shows examples of the community sharing of FIG. 8.

### DETAILED DESCRIPTION OF DISCLOSED EMBODIMENTS

The following description is of the best-contemplated mode of carrying out the disclosure. This description is made for the purpose of illustrating the general principles of the disclosure and should not be taken in a limiting sense. The scope of the disclosure is best determined by reference to the appended claims.

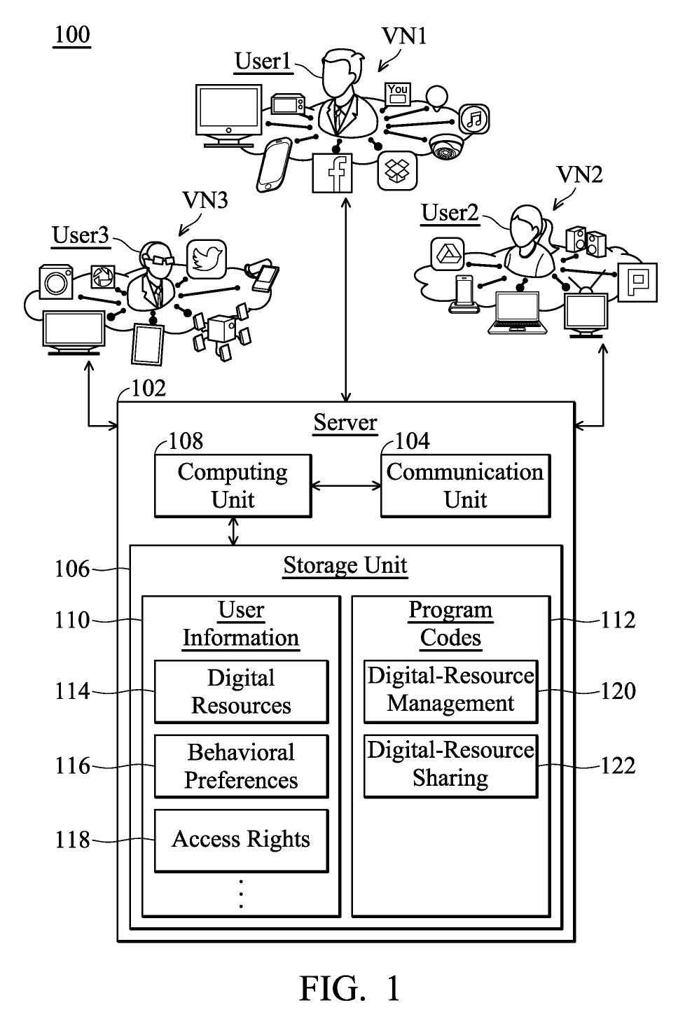

FIG. 1 depicts a management and sharing system 100 for personal digital resources in accordance with an exemplary embodiment of the disclosure, which includes a server 102 and virtual networks VN1, VN2 and VN3 of digital resources of different users

As shown in FIG. 1, the digital resources include terminal devices and internet services. The terminal devices may be personal computer systems (e.g., smartphones, personal computers, tablets, and so on), intelligent household appliances (e.g., kitchen appliances, video and audio home appliances, washing machines, electric bulbs, and so on), home medical equipment (e.g. sphygmomanometer), surveillance equipment (e.g., surveillance camera) or any electronic device directly linking to the internet or connected to a gateway to indirectly link to the internet. The internet services include social networking services (e.g., Facebook, Plurk, Twitter), internet video-sharing sites (e.g., YouTube, iTunes), internet picture-sharing sites (e.g., Flickr, Picasa), on-line storage services (e.g. Dropbox, GoogleDrive, SkyDrive), or any software or digital resource operated through internet.

The server 102 includes a communication unit 104, a storage unit 106 and a computing unit 108. The communication unit 104 links to the internet. By the communication unit 104, the computing unit 108 communicates with users User1, User2 and User3 for the virtual networks VN1, VN2 and VN3 of digital resources. The computing unit 108 allocates the storage unit 106 to provide a space for storage of user information 110 and program codes 112. The user information 110 includes digital resources 114, behavioral preferences 116 and access rights 118, to show the digital resources of the virtual networks VN1, VN2 and VN3 of users User1, User2 and User3, and further shows the behavioral preferences of each user regarding his own digital resources and the access rights to the digital resources that each user sets for other users. The program codes 112, including codes for digital-resource management 120 and codes for digital-resource sharing 122, are executed by the computing unit 108 based on the user information 110. The computing unit 108 performs calculation based on the data contained in the storage unit 106. Therefore, the computing unit 108 manages the digital resources of each user via the communication unit 104, and the digital resources are shared between the users. By the digital-resource sharing, a digital resource of a first user may also be regarded as belonging to the virtual network of a second user. Furthermore, exchange of data (i.e. digital information) of digital resources is allowed by the digital-resource sharing, which includes the exchange of text messages, files, audio streams, video streams, and so on.

In an exemplary embodiment, the computing unit 108 modifies the data contained in the storage unit 106 in accordance with the requests that the users issue through internet, to add or remove digital resources of the users, or to modify the behavioral preferences by which the users operate the digital resources, or to set access rights to the digital resources for other users. In some exemplary embodiments, the storage unit 106 is directly modified within the server 102 rather than through internet.

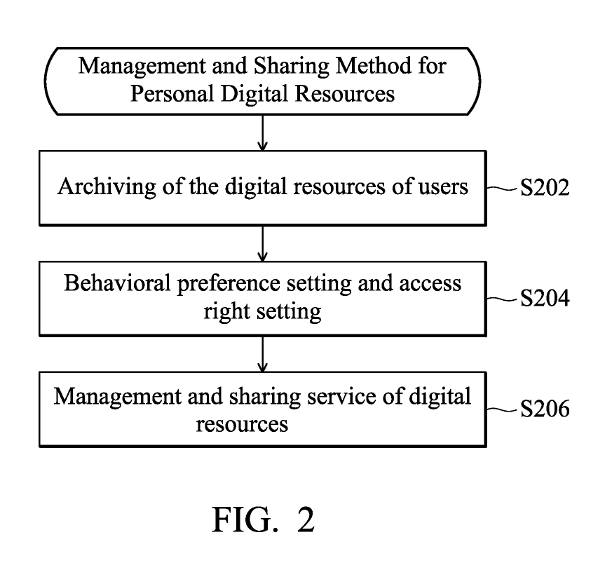

FIG. 2 is a flowchart depicting a management and sharing method for personal digital resources, discussed with respect to FIG. 1. In step S202, users User1, User2 and User3 on internet are registered and archived in the storage unit 106 with their virtual networks VN1, VN2 and VN3 of digital resources. In step S204, the behavioral preferences of the users regarding their own digital resources and the access rights to digital resources that each user sets for other users are recorded in the storage unit 106. Based on the data stored in the storage unit 106, the server 102 manages the digital resources of each user through internet and performs digital-resource sharing, including exchange of digital information, between the users in step S206.

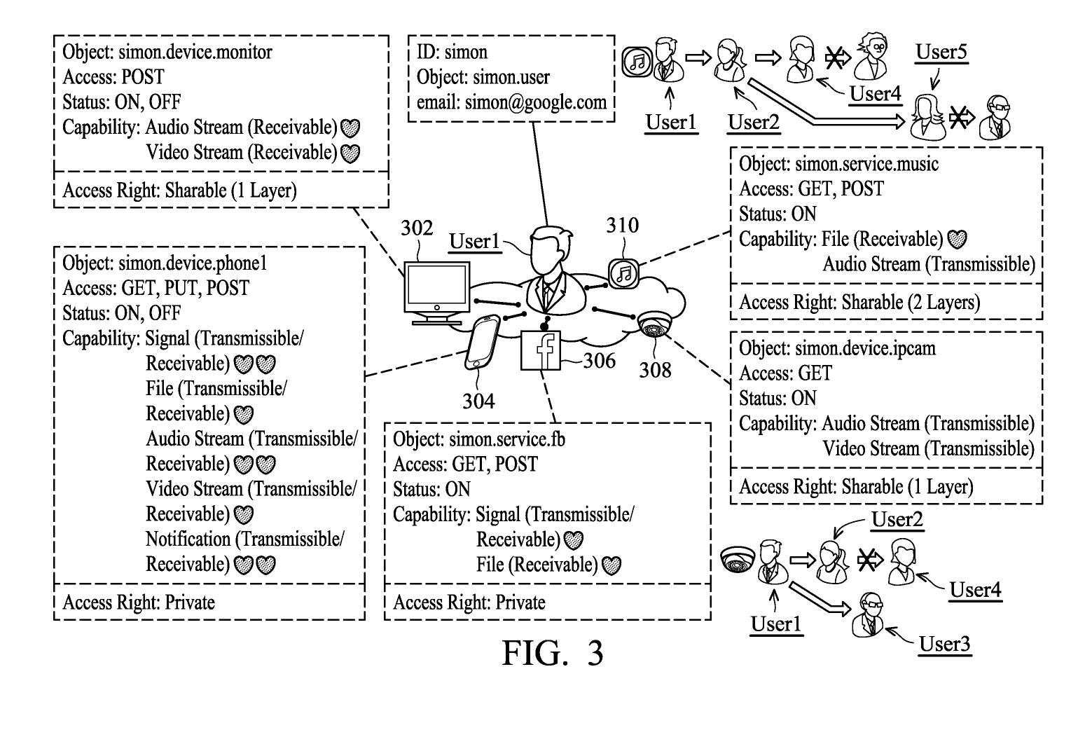

FIG. 3 shows the archiving of digital resources of a user, including the behavioral preferences of the user regarding his own digital resources and the access rights to the digital resources that the user sets for other users.

For user User1, the registered account is Simon, represented as an object, simon.user, and attached with an e-mail address. The digital resources, including a screen 302, a smartphone 304, a Facebook service 306, a surveillance camera 308 and a music display service 310 owned by the registered user User1 are also archived in the storage unit 106. About an archived digital resource, the information stored in the storage unit 106 (e.g., the space 114 of FIG. 1) includes: the name (referring to the field “Object”); access attribution (referring to the field “Access”, which may be set to a “POST” state for adding new data, or a “GET” state for retrieving data, or a “PUT” state for updating data); status (referring to the field “Status”, which may be set to “ON” or “OFF” to show the power on or off of the digital resource); and data format (referring to the field “Capability”). Based on the data contained in the storage unit 106, the server 102 manages the digital resources. For example, the data transmission and data format conversion between the digital resources may depend on the access attribution or/and the data formats of the digital resources.

Furthermore, the behavioral preferences of the owner User1 regarding the digital resources 302, 304, 306 and 310 are represented by ‘♡’. Those listed in the Capability field may be annotated with the behavioral preference information. The best-liked one is labeled with more ‘♡’. For example, the behavioral preference information may show the preferred data receiving channels of a user for the different types of digital information. The behavioral preference information may be recorded in the storage unit 106 as those stored in the space 116.

Furthermore, referring to the “Access Right” field, the access rights to the digital resources for other users are recorded in the storage unit 106 and may be stored in the space 118, showing how the digital resources are shared between the users. As shown, the surveillance camera 308 is shared only with the next layer of users, which means that the surveillance camera 308 of user User1 is accessible to users User2 and User3 but it is prohibited for user User2 to further share the surveillance camera 308 with user User4. Regarding the music display service 310, access rights are only shared only with the next two layers of users, which means that the music display service 310 of user User1 is accessible to user User2 and it is ok for user User2 to further share the music display service 310 with users User4 and User5 but it is prohibited for users User4 and User5 to further share the music display service 310 with the other users.

Based on the registration of the users, the server 102 executes the codes of digital-resource management 120 for integral communication of personal terminal devices and internet services and executes the codes of digital-resource sharing 122 for community sharing of digital terminal devices and internet services or community sharing of digital information.

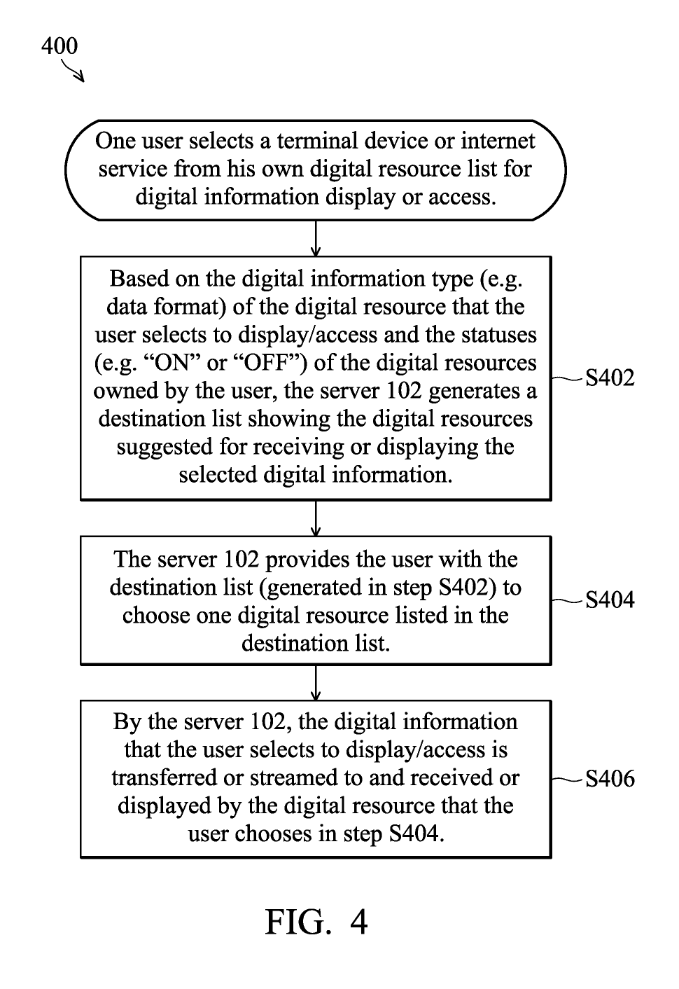

FIG. 4 is a flowchart depicting integral communication of terminal devices and internet services of one single user in accordance with an exemplary embodiment of the disclosure. When a user selects one terminal device or one internet service from the personal digital resource list of the user to display/access digital information, the process 400 for integral communication of personal terminal devices and internet services starts. In step S402, based on the digital information type (e.g. data format) of the digital resource that the user selects to display/access and the statuses (e.g. “ON” or “OFF”) of the digital resources owned by the user, the server 102 generates a destination list showing the digital resources suggested for receiving or displaying the selected digital information. In step S404, the server 102 provides the user with the destination list to choose one digital resource listed in the destination list. In step S406, by the server 102, the digital information that the user selects to display/access is transferred or streamed to and received or displayed by the digital resource that the user chooses in step S404. In step S406, the digital information may be transferred through internet and the data format conversion may be performed by the server 102.

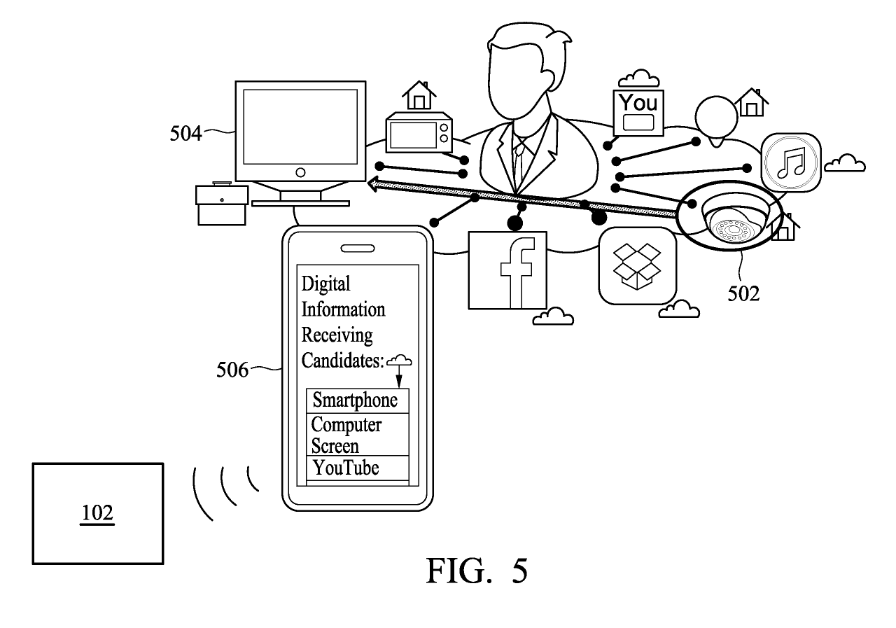

FIG. 5 shows an example of the integral communication of FIG. 4. To display the digital information captured by the surveillance camera 502 on the computer screen 504, a user GUI (Graphic User Interface) is displayed on the smartphone 506 for the user to select the surveillance camera 502 as a digital information source. In this example, the digital information source (the surveillance camera 502) is selected from the digital resources owned by the user himself. Between the digital resources of the user, the proper digital resources to receive the selected digital information are determined by the server 102 as digital information receiving candidates to be listed on the GUI displayed on the smartphone 506. As shown, through the GUI displayed on the smartphone 506, the user chooses the computer screen 504 for reception of the digital information transferred from the digital information source 502. The digital information receiving candidates are selected from the digital resources of the user depending on a data format of the digital information of the selected digital information source. Between the digital resources of the user, those compatible with the data format are determined as the digital information receiving candidates. As shown, for the surveillance camera 502 capturing videos, the smartphone 506, the computer screen 504, the YouTube service, and so on, owned by user are regarded as the proper digital information receiving candidates and are listed in the GUI displayed on the smartphone 506.

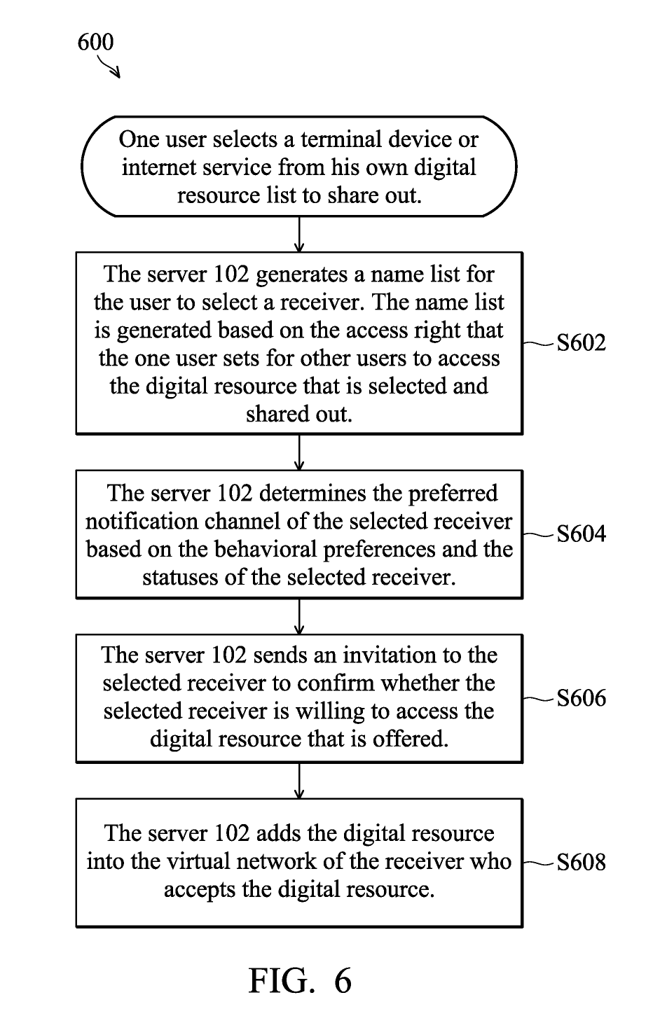

FIG. 6 is a flowchart depicting community sharing of terminal devices and internet services in accordance with an exemplary embodiment of the disclosure. When a user opens a terminal device or an internet service to share with other users, the procedure 600 for community sharing of personal terminal devices and internet services starts. In step S602, the server 102 generates a name list based on the access right to a digital resource, for the owner to select a receiver. The name list is generated based on the access right that the one user sets for other users to access the digital resource that is selected and shared out. In step S604, the server 102 determines the preferred notification channel of the selected receiver based on the behavioral preferences and the statuses of the selected receiver. The receiver statuses for reference may include on-line/off-line statuses and power on/off statuses of the digital resources owned by the selected receiver. In step S606, the server 102 sends an invitation to the selected receiver to confirm whether the selected receiver is willing to access the digital resource that is offered. In step S608, the server 102 adds the digital resource into the virtual network of the receiver who accepts the digital resource. In this manner, the shared-out digital resource regarded as belonging to the selected receiver as well.

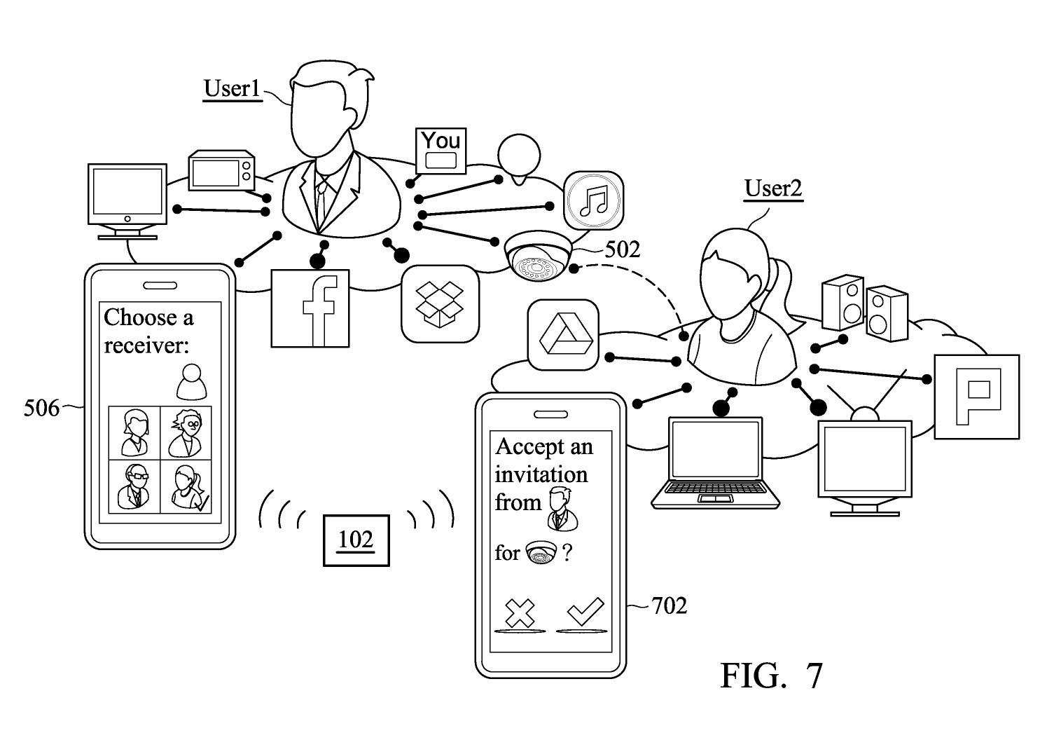

FIG. 7 shows an example of the community sharing of FIG. 6. In this example, user User1 asks user User2 to help monitor the surveillance camera 502. Users User1 and User2 each own a digital resource with a GUI application running thereon to show a GUI for communication with the server 102. As shown, the smartphone 506 of user User1 and the smartphone 702 of user User2 each present a GUI. User User1 operates the smartphone 506 to share out the surveillance camera 502. Based on the access right that user User1 set for other users to access the surveillance camera 502, the server 102 generates a name list to be presented by the GUI displayed on the smartphone 506, for user User1 to select a receiver. When user User1 operates the smartphone 506 to choose user User2 as the receiver, the server 102 calculates based on the preferred receiving channels that the user User2 sets to receive this kind of invitation and thereby selects the smartphone 702 of user User2 to display the invitation from user User1. User User2 may accept the invitation via the GUI displayed on the smartphone 702 and then the server 102 modifies the archived file to regard the surveillance camera 502 as a digital resource also belonging to user User2.

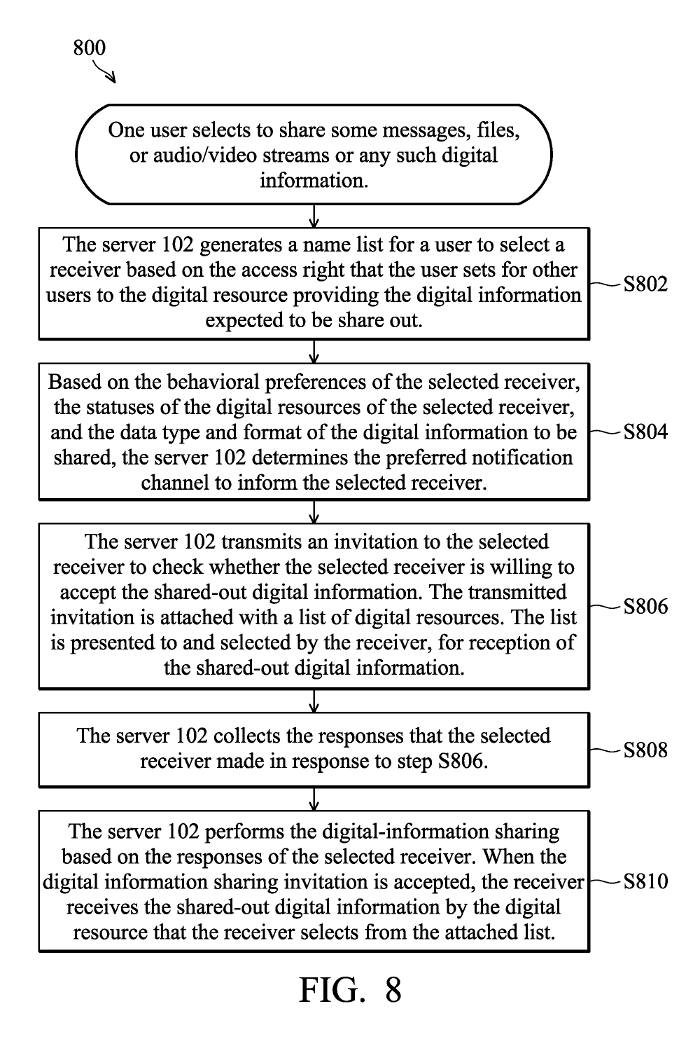

FIG. 8 is a flowchart depicting community sharing of digital information in accordance with an exemplary embodiment of the disclosure. When a user wants to share some messages, files, or audio/video streams or any such digital information, the procedure 800 for community sharing of digital information starts. In step S802, the server 102 generates a name list for a user to select a receiver based on the access right that the user sets for other users to the digital resource providing the digital information that the user wants to share out. In step S804, based on the behavioral preferences of the selected receiver, the statuses of the digital resources of the selected receiver, and the data type and format of the digital information to be shared, the server 102 determines the preferred notification channel to inform the selected receiver. In step S806, the server 102 transmits an invitation to the selected receiver, to check whether the selected receiver is willing to accept the shared-out digital information. The transmitted invitation is attached with a list of digital resources. The list is presented to and selected by the receiver, for reception of the shared-out digital information. In step S808, the server 102 collects the responses that the selected receiver made in response to step S806. In step S810, the server 102 performs the digital-information sharing based on the responses of the selected receiver, to share the digital information to the selected receiver when the digital information sharing invitation is accepted. The receiver receives the shared-out digital information by the digital resource that the receiver selects from the attached list.

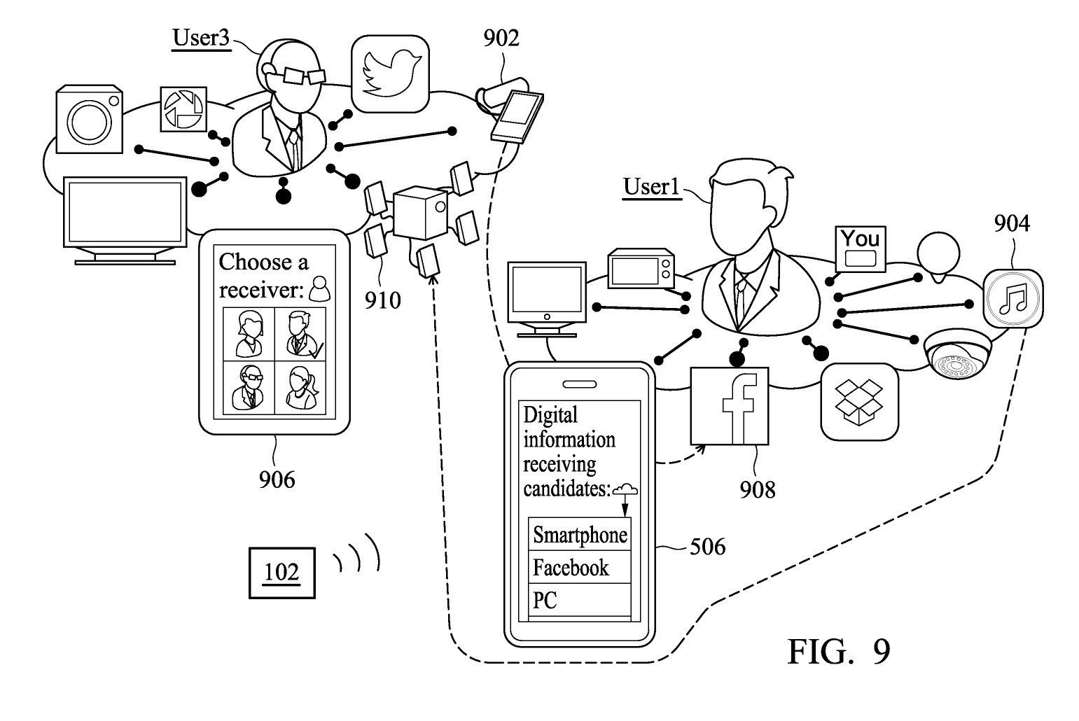

FIG. 9 shows examples of the community sharing of FIG. 8, wherein user User1 wants to monitor the sphygmomanometer 902 of user User3 and also wants to share the music display service 904 with user User3.

As shown, the smartphone 506 of user User1 and the tablet 906 of user User3 are each installed with a GUI. By operating the GUI displayed on the tablet 906, user User3 chooses the sphygmomanometer 902 as a digital information source. Based on the access right that user User3 sets for other users to the sphygmomanometer 902, the server 102 generates a name list to be presented by the GUI displayed on the tablet 906. When user User3 selects user User1 from the name list presented by the GUI of the tablet 906, the server 102 determines, based on the behavioral preferences of user User1 about his own digital resources, that the smartphone 506 is the preferred notification channel of user User1 to show an invitation from other users. When user User1 accepts the invitation from user User3 via the GUI displayed on the smartphone 506, the server 102 determines at least one digital information receiving candidate for the blood pressure values measured by the sphygmomanometer 902, to form a list of receiving channels. The list is presented on the smartphone 506 to be selected by user User1 for the reception of blood pressure values measured by the sphygmomanometer 902. As shown, user User1 operates the GUI displayed on the smartphone 506 to select Facebook service 908, and the server 102 informs user User1 of the blood pressure values measured by the sphygmomanometer 902 through the Facebook service 908.

The music display service 904 owned by user User1 may be shared with user User3 in a similar way, to be played by audio speaker 910. By operating the smartphone 506, user User1 may choose the music display service 904 as the digital information source. Based on the access right that user User1 sets for other users to access the music display service 904, the server 102 generates a name list to be presented by the GUI displayed on the smartphone 506. When user User1 chooses user User3 from the name list presented by the GUI of the smartphone 506, the server 102 selects, based on the behavioral preferences that user User3 sets for his own digital resources, the tablet 906 to display the invitation from user User1. When user User3 accepts the invitation via the GUI displayed on the tablet 906, the server 102 determines at least one digital information receiving candidate from the digital resources of user User3 to form a list of digital information receivers, for reception of the audio signal provided from the music display service 904. The list is presented on the tablet 906 to be selected by User User3. When user User3 operates the GUI of the tablet 906 to choose the audio speaker 910, the server 102 directs the audio signal provided from the music display service 904 of user User1 to be played by the audio speaker 910 of user User3.

In some exemplary embodiments, the users may download applications from the server 102 and install and run the applications on their digital resources to show GUIs for communication between the users and the server 102.

While the disclosure has been described by way of example and in terms of the preferred embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A server, comprising:
a communication unit for linking to the internet;
a storage unit; and
a computing unit communicating with a plurality of users through internet via the communication unit,
wherein:
by the computing unit, the users and digital resources including terminal devices and internet services of the users are archived in the storage unit;
by the computing unit, the behavioral preferences of each user regarding his own digital resources and the access rights to the digital resources that each user sets for other users are recorded into the storage unit; and
based on data contained in the storage unit and via the communication unit, the computing unit manages the digital resources of each user and the digital resources are shared between the users.

2. The server as claimed in claim 1, wherein:
by the computing unit, access attribution and data formats of the digital resources of the users are stored into the storage unit for data transmission and data format conversion between the digital resources.

3. The server as claimed in claim 1, wherein:
when a specific user selects one of his own digital resources as a digital information source, the computing unit determines at least one digital information receiving candidate from the digital resources of the specific user to form a list for the specific user to choose for reception of digital information from the digital information source.

4. The server as claimed in claim 3, wherein:
the digital resource owned by the specific user and compatible with the digital information of the digital information source is regarded as one digital information receiving candidate.

5. The server as claimed in claim 1, wherein:
when a first user selects one terminal device or internet service from his own digital resource list to share out, the computing unit generates a name list based on the access right that the first user sets for other users to access the digital resource that is selected and shared out, and the name list is displayed for the first user for selection of a second user;
based on the behavioral preferences of the second user regarding his own digital resources, the computing unit chooses one digital resource of the second user for display of an invitation from the first user about the sharing of the digital resource; and
when the second user accepts the invitation, the computing unit modifies the data contained in the storage unit and thereby the digital resource that is selected and shared out by the first user is regarded as one digital resource of the second user.

6. The server as claimed in claim 1, wherein:
when a first user selects one of his own digital resources as a digital information source, the computing unit generates a name list based on the access right that the first user sets for other users to access the digital information source, and the name list is displayed for the first user for selection of a second user;
based on the behavioral preferences of the second user regarding his own digital resources, the computing unit chooses one digital resource of the second user for display of an invitation from the first user about the sharing of the digital information source; and
when the second user accepts the invitation, the computing unit determines at least one digital information receiving candidate from the digital resources owned by the second user, to form a list to be selected by the second user for reception of data provided from the digital information source.

7. The server as claimed in claim 1, wherein:
in response to requests that the users issue through internet via the communication unit, the computing unit modifies the data contained in the storage unit and thereby updates the digital resources of each user or updates the behavioral preferences of each user regarding his own digital resources or the access rights to the digital resources that each user sets for other users.

8. A management and sharing system for personal digital resources, comprising:
a server as claimed in claim 1; and
the digital resources of the users.

9. The system as claimed in claim 8, wherein:
the users each have at least one digital resource having a GUI application installed and executed thereon for communication between the users and the server.

10. A management and sharing method for personal digital resources, comprising:
archiving digital resources including terminal devices and internet services of users on internet in a storage unit of a server;
recording the behavioral preferences of each user regarding his own digital resources and the access rights to the digital resources that each user sets for other users into the storage unit; and
based on data contained in the storage unit, driving the server to manage the digital resources of each user through internet and make the digital resources shared between the users through internet.

11. The method as claimed in claim 10, further comprising:
recording access attribution and data formats of the digital resources of the users into the storage unit for data transmission and data format conversion between the digital resources.

12. The method as claimed in claim 10, wherein:
when a specific user selects one of his own digital resources as a digital information source, at least one digital information receiving candidate is obtained from the digital resources of the specific user to form a list for the specific user to choose for reception of digital information from the digital information source.

13. The method as claimed in claim 12, wherein:
the digital resource owned by the specific user and compatible with the digital information of the digital information source is regarded as one digital information receiving candidate.

14. The method as claimed in claim 10, wherein:
when a first user selects one terminal device or internet service from his own digital resource list to share out, a name list is generated based on the access right that the first user sets for other users to access the digital resource that is selected and shared out, and the name list is displayed for the first user for selection of a second user;
based on the behavioral preferences of the second user regarding his own digital resources, one digital resource of the second user is chosen to display an invitation from the first user about the sharing of the digital resource; and
when the second user accepts the invitation, the data contained in the storage unit is modified and thereby the digital resource that is selected and shared out by the first user is also regarded as one digital resource of the second user.

15. The method as claimed in claim 10, wherein:
when a first user selects one of his own digital resources as a digital information source, a name list is generated based on the access right that the first user sets for other users to access the digital information source, and the name list is displayed for the first user for selection of a second user;
based on the behavioral preferences of the second user regarding his own digital resources, one digital resource of the second user is chosen to display an invitation from the first user about the sharing of the digital information source; and
when the second user accepts the invitation, at least one digital information receiving candidate is obtained from the digital resources owned by the second user, to form a list to be selected by the second user for reception of data provided from the digital information source.

16. The method as claimed in claim 10, wherein:
in response to requests that the users issue through internet, the data contained in the storage unit is modified and thereby the digital resources of each user, or the behavioral preferences of each user regarding his own digital resources, or the access rights to the digital resources that each user sets for other users are updated.

17. The method as claimed in claim 10, further comprising:
installing and executing a GUI application on at least one digital resource of each user, for management and sharing of the digital resources.
